(19) United States
(12) Patent Application Publication
(10) Pub. No.: US 2018/0203850 A1
(43) Pub. Date: Jul. 19, 2018

(54) Method for Multilingual Translation in Network Voice Communications

(71) Applicant: FREEFLY881 COMMUNICATIONS INC., Beijing (CN)

(72) Inventors: Edward ZHENG, Beijing (CN); Raymond KWAN, Beijing (CN)

(21) Appl. No.: 15/871,898

(22) Filed: Jan. 15, 2018

(30) Foreign Application Priority Data
Jan. 17, 2017 (CN) 201710031396.X

(51) Int. Cl. G06F 17/28; G06F 17/27; H04M 7/00

(52) U.S. Cl. CPC G06F 17/289; G06F 17/2735; H04M 2242/12; H04M 7/006; G06F 17/275

(57) ABSTRACT

The disclosure relates to a method for realizing multilingual translation in network voice communications, the method comprising: each of a plurality of mobile terminal voice communication information systems establishing a one-to-one communication data transmission channel with a multilingual integrated translation platform, the plurality of mobile terminal voice communication information systems being used for the conversion between their own voice communication signals and communication data packets, each mobile terminal voice communication information system serving as both a source language system and a target language system, a communication data packet of the source language system being sent to the multilingual integrated translation platform, the multilingual integrated translation platform performing an integrated translation according to a received translation language request sent by the target language system and sending the translated communication data packet to the target language system.

### CROSS-REFERENCE OF THE RELATED APPLICATIONS

The present application is based upon and claims priority of Chinese Patent Application No. 201710031396.X, filed before Chinese Patent Office on Jan. 17, 2017 and entitled “Method for Multilingual Translation in Network Voice Communications,” the entire contents of which is incorporated herein by reference.

### TECHNICAL FIELD

The present disclosure relates to the field of network communication technologies, and in particular, to a method for multilingual translation in network voice communications.

### BACKGROUND

With the development of Wi-Fi and mobile Internet, the coverage thereof is becoming wider and wider, and the sharing property of the Internet brings great convenience to people. In the field of communications, free calls have been generated by utilizing the sharing property of the Internet. For example, Skype has realized global toll free phones.

With the development of communication technologies, mobile terminals have increased functions, and mobile terminal users are over the worldwide. As people from the different countries use the different languages, when two persons from the different countries talk to each other through the mobile terminals, they might not communicate effectively as they couldn't understand each other's language, whereby a mobile terminal with a translation function has been generated.

When the user of a mobile terminal with a translation function in the prior art uses the translation function to communicate with the other side, the mobile terminal is connected to a voice translation server terminal. However, through a voice translation server terminal, the voice communication from a local mobile terminal can be translated only into a local language rather than into the language required by a remote mobile terminal for transmission to the remote mobile terminal, so as to realize the real-time voice translation function. Furthermore, among current network voice communications, simultaneous multiple-people communication has been realized, but the current voice translation server cannot realize the function of simultaneous real-time multilingual translation.

### SUMMARY

To solve the problem, an object of the present disclosure is to provide a method for realizing multilingual translation in network voice communications, which is used for solving the problem that currently voice translation servers cannot translate voice communication of a local mobile terminal into the voice required by a remote mobile terminal for transmission to the remote mobile terminal and cannot realize simultaneous real-time multilingual translation.

To achieve the object, the present disclosure provides a method for realizing multilingual translation in network voice communications, comprising: each of a plurality of mobile terminal voice communication information systems establishing a one-to-one communication data transmission channel with a multilingual integrated translation platform, the plurality of mobile terminal voice communication information systems being used for the conversion between their own voice communication signals and communication data packets, each mobile terminal voice communication information system serving as both a source language system and a target language system, a communication data packet of the source language system being sent to the multilingual integrated translation platform, the multilingual integrated translation platform performing an integrated translation according to a received translation language request sent by the target language system and sending the translated communication data packet to the target language system.

In the method for realizing multilingual translation in network voice communications disclosed in the present disclosure, the translated communication data packet sent by the multilingual integrated translation platform to the target language system through the communication data transmission channel is a voice data packet.

In the method for realizing multilingual translation in network voice communications disclosed in the present disclosure, the communication data packet sent by the source language system to the multilingual integrated translation platform through the communication data transmission channel is a voice data packet or a text data packet.

In the method for realizing multilingual translation in network voice communications disclosed in the present disclosure, the multilingual integrated translation platform performing an integrated translation according to a received translation language request sent by the target language system comprises: recognizing a voice data packet and a text data packet of the source language using a voice recognition dictionary and a text recognition dictionary for recognizing the source language; converting the voice data packet or the text data packet of the source language into a source sentence; and translating the source sentence of the source language, according to the translation language request sent by the target language system, into a target language sentence; converting the target language sentence into the target voice data packet; and sending the target voice data packet to the target language system.

In the method for realizing multilingual translation in network voice communications disclosed in the present disclosure, the multilingual integrated translation platform comprises: a voice data interface, configured to receive a voice data packet of a source language through a communication data transmission channel; a voice recognition unit, configured to recognize the voice data packet by using a voice recognition dictionary for recognizing the source language, and convert the voice data packet of the source language into a source sentence; a translation unit, configured to translate the source sentence of the source language according to a translation language request sent by the target language system, into a target language sentence; a data conversion unit, configured to convert the target language sentence into a target voice data packet; a voice data output port, configured to output and send the target voice data packet through the communication data transmission channel.

In the method for realizing multilingual translation in network voice communications disclosed in the present disclosure, the multilingual integrated translation platform further comprises: a text data interface, configured to receive a text data packet of a source language through a communication data transmission channel; and a text recognition unit, configured to recognize the text data packet by using a text recognition dictionary for recognizing the source language and convert the text data packet of the source language into a source sentence.

In the method for realizing multilingual translation in network voice communications disclosed in the present disclosure, the translation unit is installed onto a server of the multilingual integrated translation platform connected by network connection with the source language system and the target language system, and the source language system and the target language system share the translation unit.

In the method for realizing multilingual translation in network voice communications disclosed in the present disclosure, the translation unit is directly installed onto the source language system and the target language system, and the server of the multilingual integrated translation platform calls the translation unit on the source language system and the target language system through a remote network control.

In the method for realizing multilingual translation in network voice communications disclosed in the present disclosure, there are simultaneously multiple said source language systems and/or said target language systems.

In the method for realizing multilingual translation in network voice communications disclosed in the present disclosure, each mobile terminal is installed with one said mobile terminal voice communication information system or one mobile terminal application program containing the mobile terminal voice communication information system.

The disclosure has the following advantages:

The method for realizing multilingual translation in network voice communications disclosed in the present disclosure, translating a source language sentence of a local mobile terminal provided by a source language user into a target language sentence through a server of a multilingual integrated translation platform, converting the target language into a target voice data packet required by a remote mobile terminal and transmitting to the remote mobile terminal through a communication data transmission channel to realize the function of simultaneous real-time multilingual voice translation.

### BRIEF DESCRIPTION OF THE DRAWINGS

FIG. 1 is a logic block diagram of an embodiment of a method for realizing multilingual translation in network voice communications according to the present disclosure.

FIG. 2 is a logic block diagram of another embodiment of the method for realizing multilingual translation in network voice communications according to the present disclosure.

FIG. 3 is a flowchart of a multilingual integrated translation platform performing an integrated translation according to a received translation language request sent by a target language system according to the present disclosure.

FIG. 4 is a structural block diagram of the multilingual integrated translation platform in the present disclosure.

### DETAILED DESCRIPTION

The following embodiments illustrate the present disclosure, but are not intended to limit the scope of the present disclosure.

### Embodiment 1

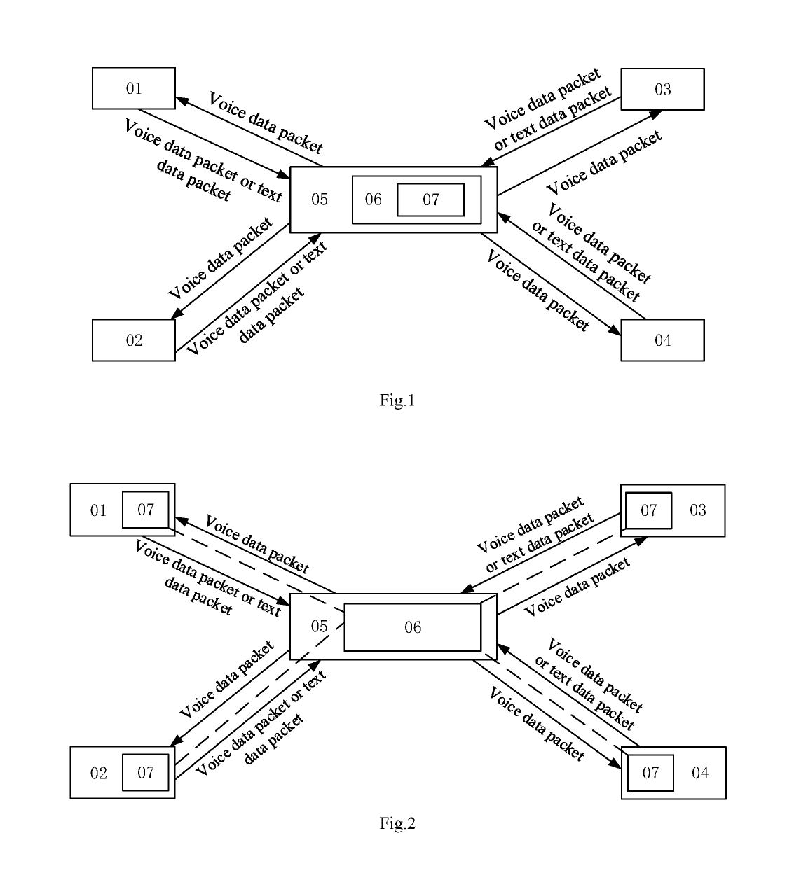

Referring to FIG. 1 and FIG. 2, a method for realizing multilingual translation in network voice communications according to this embodiment comprises: each of the first to fourth mobile terminal voice communication information systems 01, 02, 03 and 04 establishing a one-to-one communication data transmission channel with a multilingual integrated translation platform 05, the first to fourth mobile terminal voice communication information systems being used for the conversion between their own voice communication signals and communication data packets, the first to fourth mobile terminal voice communication information system serving as both a source language system and a target language system, a communication data packet of the source language system being sent to the multilingual integrated translation platform 05, the multilingual integrated translation platform 05 performing an integrated translation according to a received translation language request sent by the target language system, and sending the translated communication data packet to the target language system.

In the embodiment described above, as long as one of multiple communication parties requests, through the mobile terminal thereof, the multilingual integrated translation platform 05 to translate the voice from the mobile terminal of one or more of the other parties into their language to the voice of its own language, the method described above may realize the multilingual translation function in network voice communications. In addition, each mobile terminal is installed with a mobile terminal voice communication information system or a mobile terminal application program containing the mobile terminal voice communication information system, and there are simultaneously multiple said source language systems and/or said target language systems. The present embodiment further enables multiple parties of communication to realize multilingual translation in the network voice communications.

Referring to FIG. 1, in this embodiment, the translation unit 07 may be installed onto a server 06 of the multilingual integrated translation platform 05 connected by network connection with the source language system and the target language system network. The source language system and the target language system may share the same translation unit 07. In addition, referring to FIG. 2, the translation unit 07 may also be directly installed onto the source language system and the target language system. The server 06 of the multilingual integrated translation platform 05 calls the translation unit 07 on the source language system and the target language system through a remote network control, so that each mobile terminal voice communication information system has a translation unit 07, more conducive to improve the speed of translation. Further, with reference to FIG. 1 and FIG. 2, the translated communication data packet sent by the multilingual integrated translation platform 05 in this embodiment to the target language system through the communication data transmission channel is a voice data packet, and the communication data packet sent by the source language system to the multilingual integrated translation platform 05 through the communication data transmission channel is a voice data packet or a text data packet.

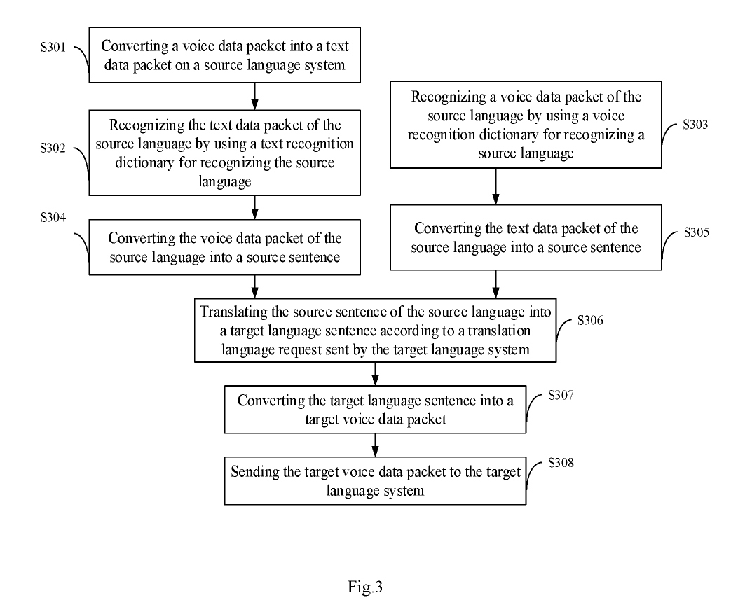

With reference to FIG. 3, in the method for realizing multilingual translation in network voice communications disclosed in the present disclosure, the multilingual integrated translation platform performing an integrated translation according to a received translation language request sent by the target language system comprises the following steps.

The process of performing a multilingual translation of a text data packet comprises:

S301: converting a voice data packet into a text data packet on the source language system;

S302: recognizing the text data packet of the source language by using a text recognition dictionary for recognizing the source language;

S304: converting the text data packet of the source language into a source sentence;

S306: translating the source sentence of the source language into a target language sentence according to a translation language request sent by the target language system;

S307: converting the target language sentence into a target voice data packet;

S308: sending the target voice data packet to the target language system.

The process of performing multi-lingual translation of the voice data packet comprises:

S303: recognizing a voice data packet by using a voice recognition dictionary for recognizing a source language;

S305: converting the voice data packet of the source language into a source sentence;

S306: translating the source sentence of the source language into a target language sentence according to a translation language request sent by the target language system;

S307: converting the target language sentence into the target voice data packet;

S308: sending the target voice data packet to the target language system.

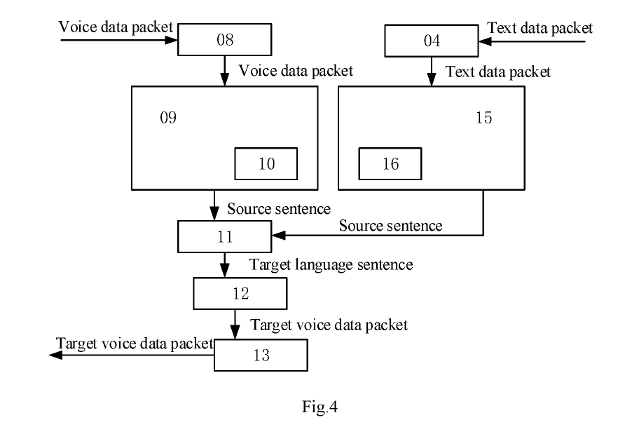

With reference to FIG. 4, the multilingual integrated translation platform of the present embodiment comprises: a voice data interface 08, configured to receive a voice data packet of a source language through a communication data transmission channel; a voice recognition unit 09, configured to recognize the voice data packet by using a voice recognition dictionary 10 for recognizing the source language, and convert the voice data packet of the source language into a source sentence; a translation unit 11, configured to translate the source sentence of the source language according to a translation language request sent by the target language system into a target language sentence, wherein the source sentence and the target language sentence described above exist in the format that may be used by the running translation unit, such as in the form of program source language; a data conversion unit 12, configured to convert the target language sentence into a target voice data packet; a voice data output port 13, configured to output and send the target voice data packet through the communication data transmission channel.

In addition, the multilingual integrated translation platform further comprises: a text data interface 14, configured to receive a text data packet of the source language through the communication data transmission channel; and a text recognition unit 15, configured to recognize the text data packet by using a text recognition dictionary 16 for recognizing the source language and convert the text data packet of the source language into a source sentence.

Although the disclosure has been described in detail in the foregoing by way of a generic description and specific embodiments, it will be apparent to those skilled in the art that certain modifications or improvements may be made thereto based on the disclosure. Therefore, these modifications or improvements made without departing from the spirit of the present disclosure all fall within the protection scope of the present disclosure.

What is claimed is:

1. A method for realizing multilingual translation in network voice communications, comprises:
establishing, by each of a plurality of mobile terminal voice communication information systems, a one-to-one communication data transmission channel with a multilingual integrated translation platform; the plurality of mobile terminal voice communication information systems being used for the conversion between their own voice communication signals and communication data packets, each mobile terminal voice communication information system serving as both a source language system and a target language system, a communication data packet of the source language system being sent to the multilingual integrated translation platform;
performing, by the multilingual integrated translation platform, an integrated translation according to a received translation language request sent by the target language system; and
sending the translated communication data packet to the target language system.

2. The method for realizing multilingual translation in network voice communications according to claim 1, wherein the translated communication data packet sent by the multilingual integrated translation platform to the target language system through the communication data transmission channel is a voice data packet.

3. The method for realizing multilingual translation in network voice communications according to claim 1, wherein the communication data packet sent by the source language system to the multilingual integrated translation platform through the communication data transmission channel is a voice data packet or a text data packet.

4. The method for realizing multilingual translation in network voice communications according to claim 1, wherein performing, by the multilingual integrated translation platform, an integrated translation according to a received translation language request sent by the target language system comprises:
recognizing a voice data packet and a text data packet in the source language using a voice recognition dictionary and a text recognition dictionary for recognizing the source language;
converting the voice data packet or the text data packet of the source language into a source sentence;
translating the source sentence of the source language, according to the translation language request sent by the target language system, into a target language sentence;
converting the target language sentence into a target voice data packet; and
sending the target voice data packet to the target language system.

5. The method for realizing multilingual translation in network voice communications according to claim 1, wherein the multilingual integrated translation platform comprises:
a voice data interface, configured to receive a voice data packet of a source language through a communication data transmission channel;
a voice recognition unit, configured to recognize the voice data packet by using a voice recognition dictionary for recognizing the source language, and convert the voice data packet of the source language into a source sentence;
a translation unit, configured to translate the source sentence of the source language according to a translation language request sent by the target language system, into a target language sentence;
a data conversion unit, configured to convert the target language sentence into a target voice data packet; and
a voice data output port, configured to output and send the target voice data packet through the communication data transmission channel.

6. The method for realizing multilingual translation in network voice communications according to claim 5, wherein the multilingual integrated translation platform further comprises:
a text data interface, configured to receive a text data packet of a source language through a communication data transmission channel; and
a text recognition unit, configured to recognize the text data packet by using a text recognition dictionary for recognizing the source language and convert the text data packet of the source language into a source sentence.

7. The method for realizing multilingual translation in network voice communications according to claim 5, wherein the translation unit is installed on a server of the multilingual integrated translation platform connected by network connection with the source language system and the target language system, and the source language system and the target language system share the translation unit.

8. The method for realizing multilingual translation in network voice communications according to claim 5, wherein the translation unit is directly installed on the source language system and the target language system, and the server of the multilingual integrated translation platform calls the translation unit on the source language system and the target language system through a remote network control.

9. The method for realizing multilingual translation in network voice communications according to claim 5, wherein there are simultaneously multiple said source language systems and/or said target language systems.

10. The method for realizing multilingual translation in network voice communications according to claim 5, wherein each mobile terminal is installed with one said mobile terminal voice communication information system or one mobile terminal application program containing said mobile terminal voice communication information system.
